(19) United States
(12) Patent Application Publication
(10) Pub. No.: US 2004/0040423 A1
(43) Pub. Date: Mar. 4, 2004

(54) Drive device for a spiral screwdriver

(76) Inventor: Kun-Chih Hung, Ta-Li City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/233,652

(22) Filed: Sep. 4, 2002

(51) Int. Cl. B25B 23/16

(52) U.S. Cl. 81/177.75

(57) ABSTRACT

A drive device for a spiral screwdriver includes a barrel having a first end longitudinally and co-axially secured in a handle of the spiral screwdriver, and a second end formed with a distal flat. A polygonal hole is longitudinally defined in the barrel and extends to the distal flat of the barrel. An axle is movably and partially received in the polygonal hole, and has a polygonal cross-section corresponding to that of the polygonal hole. A locking member extends through the barrel and the axle in the barrel to selectively hold the axle in place. A chuck is selectively universally mounted to a free end of the axle and has a distal flat formed to selectively abut the distal flat on the barrel.

### BACKGROUND OF THE INVENTION

1. Field of the Invention

The present invention relates to a drive device, and more particularly to a drive for a spiral screwdriver.

2. Description of Related Art

A conventional drive device for a spiral screwdriver in accordance with the prior art shown in FIG. 8 comprises barrel (6) adapted to be co-axially securely to a handle (not numbered) of the spiral screwdriver, a threaded rod (7) screwed into the barrel (6) and a chuck (8) pivotally mounted on a free end of the threaded rod (7).

The barrel (6) includes a threaded hole (61) centrally and longitudinally defined in the barrel (6) and the threaded rod (7) is screwed into the threaded hole (61) in the barrel (6). The threaded rod (7) includes a spheroid portion (71) formed on the free end thereof. The chuck (8) includes a first end having a socket (82) defined to pivotally receive the spheroid portion (71) of the threaded rod (7) and a second end having a polygonal hole (81) longitudinally defined in the chuck (8) for partially receiving a tip (not shown) to tighten or loosen a screw. A pin (80) extends through the chuck (8) and the spheroid portion of the threaded rod (7) to prevent the chuck (8) from detaching from the threaded rod (7). The chuck (8) is fixed when the threaded rod (7) screwed into the threaded hole (61) in the barrel (6) to make the chuck (8) abut a distal face of the barrel (6) opposite to the handle of the screwdriver.

However, the threaded rod (7) should be rotated during operating because there is not any locking member to limit the threaded. Consequently, the conventional drive device for a spiral screwdriver needs to be advantageously altered.

The present invention has arisen to mitigate and/or obviate the disadvantages of the conventional drive device for a spiral screwdriver.

### SUMMARY OF THE INVENTION

The main objective of the present invention is to provide an improved drive device for a spiral screwdriver.

To achieve the objective, the drive device in accordance with the present invention comprises a barrel having a first end longitudinally and co-axially secured in a handle of the spiral screwdriver, and a second end formed with a distal flat. A polygonal hole is longitudinally defined in the barrel and extends to the distal flat of the barrel. An axle is movably and partially received in the polygonal hole, and has a polygonal cross-section corresponding to that of the polygonal hole. A locking member extends through the barrel and the axle in the barrel to selectively hold the axle in place. A chuck is selectively universally mounted to a free end of the axle and has a distal flat formed to selectively abut the distal flat on the barrel.

Further benefits and advantages of the present invention will become apparent after a careful reading of the detailed description with appropriate reference to the accompanying drawings.

### BRIEF DESCRIPTION OF THE DRAWINGS

FIG. 1 is a perspective schematic view of a drive device for a spiral screwdriver in accordance with the present invention;

FIG. 2 is a perspective view of the drive device for a spiral screwdriver of the present invention;

FIG. 3 is an exploded perspective view of the drive device in FIG. 2;

FIG. 4 is a cross-sectional side plan view of the drive device in FIG. 2 when the chuck is fixed on the barrel;

FIG. 5 is an operational plan view of a locking member of the drive device of the present invention;

FIG. 6 is a cross-sectional side plan view of the drive device in FIG. 2 when the chuck is rotatable relative to the barrel;

FIG. 7 is a perspective schematic view of the drive device of the present invention when the chuck apart from the barrel; and

FIG. 8 is a cross-sectional side plan view of a drive device for a spiral screwdriver in accordance with the prior art.

### DETAILED DESCRIPTION OF THE INVENTION

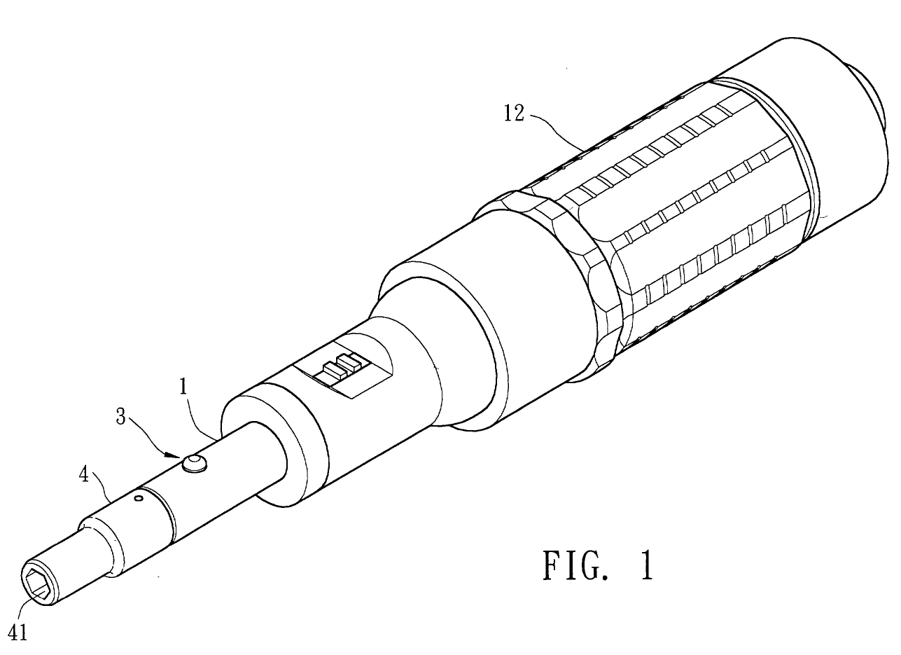

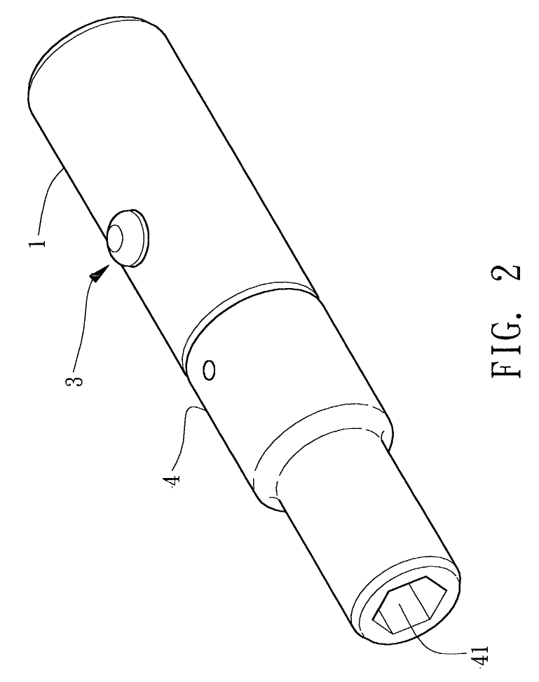

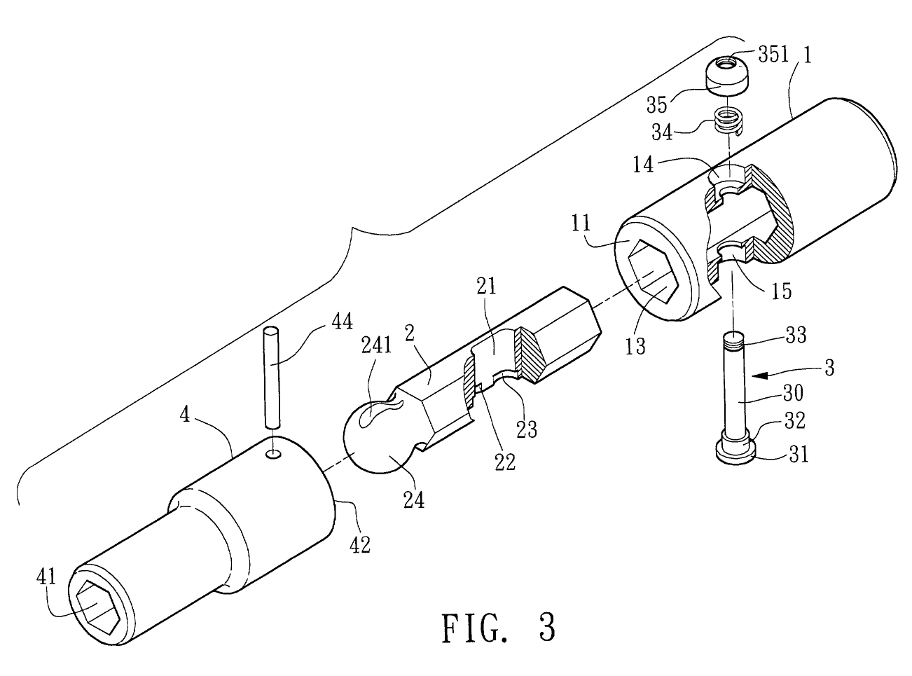

Referring to the drawings and initially to FIGS. 1-3, a drive device for a spiral screwdriver in accordance with the present invention comprises a barrel (1), an axle (2) slidably partially received in the barrel (1), a locking member (3) diametrically extending into the barrel (1) to hold the axle (2) in place and a chuck (4) selectively universally mounted on one end of the axle (2) opposite to the barrel (1).

The barrel (1) is adapted to be longitudinally and co-axially securely connected to a handle (12) of the spiral screwdriver and a distal flat (11) formed opposite to the handle (12). A polygonal hole (13) is centrally and longitudinally defined in the barrel (1). A first sunken hole (14) and a second sunken hole (15) are defined in an outer periphery of the barrel (1). The first sunken hole (14) and the second sunken hole (15) diametrically correspond to each other relative to the barrel (1) and communicate with the polygonal hole (13) in the barrel (1).

The axle (2) has a polygonal cross-section. The shape of the cross-section of the axle (2) corresponds to that of the polygonal hole (13) in the barrel (1) such that the axle (2) only longitudinally moves in the barrel (1). The axle (2) includes a slot (21) diametrically defined in the axle (2) and corresponding to the first sunken hole (14) and the second sunken hole (15) of the barrel (1). A first recess (22) and a second recess (23) each is defined in an outer periphery of the axle (2) and centrally communicates with the slot (21) in the axle (2). The first recess (22) and the second recess (23) selectively communicate with the second sunken hole (15). There is a distance between the first recess (22) and the chuck (4), which is shorter than that between the second recess (23) and the chuck (4). The axle (2) has spheroid portion (24) formed on one end of the axle (2) opposite to the handle (12). The spheroid portion (24) has a sandglass-shaped passage (241) diametrically defined in and extending through the spheroid portion (24).

The locking member (3) includes a dish (31) movably received in the second sunken hole (15) and a stopper (32) extending from the dish (31). The stopper (32) extends into the axle (2) and received in the first recess (22)/second recess (23) to prevent the axle (2) from detaching from the barrel (1) and selectively locked the axle (2) in the barrel (1). The stopper (32) has a diameter smaller than that of the first recess (22) and the second recess (23), and greater than a width of the slot (21) in the axle (21). The locking member (3) includes a shank (30) extending from the stopper (32) and having a free end extending through the barrel (1). A button (35) is mounted on the free end of the shank (30) to prevent the locking member (3) from detaching from the barrel (1). The shank (30) has a threaded portion (33) formed on the free end thereof and the button (35) has a threaded hole (351) centrally defined in the button (35) such that the button (35) is screwed onto the threaded portion (33) of the shank (30). A spring (34) is compressively mounted around the shank (30) and has two opposite ends respectively abutting a bottom of the first sunken hole (14) and the button (35).

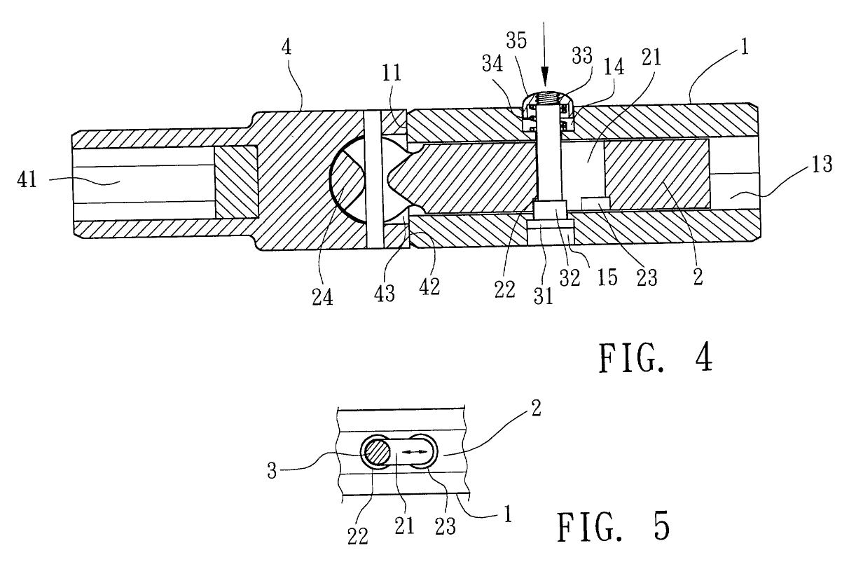

Further with reference to FIG. 4, the chuck (4) comprises a locking pin (44) extending through the chuck (4) and the passage (241) in the spheroid portion (24) of the axle (2) to prevent the chuck (4) from detaching from the axle (2). The chuck (4) includes a first end having a socket (43) defined to universally receive the spheroid portion (24) of the axle (2) and a distal flat (42) formed and facing the distal flat (11) of the barrel (1), and a second end having a polygonal hole (41) defined in the chuck (4). The polygonal hole (41) in the chuck (4) is adapted to receive a tip (not shown) for tightening or loosening a work piece (not shown). The distal flat (42) of the chuck (4) is selectively abutted the distal flat (11) of the barrel (1) such that the chuck (4) longitudinally corresponds to the barrel (1) and co-axially fixed on the barrel (1) due to the axle (2) and the locking member (3).

With reference to FIG. 4, in an original condition, the stopper (32) is engaged to the first recess (22) in the axle (2) such that the chuck (4) is pulled to make the distal flat (42) of the chuck (4) securely abutting the distal flat (11) of the barrel (1), thus the chuck (4) longitudinally and co-axially corresponds to the barrel (1), and the screwdriver with the present invention is used as an ordinary screwdriver because the work piece and the screwdriver are along a same axis.

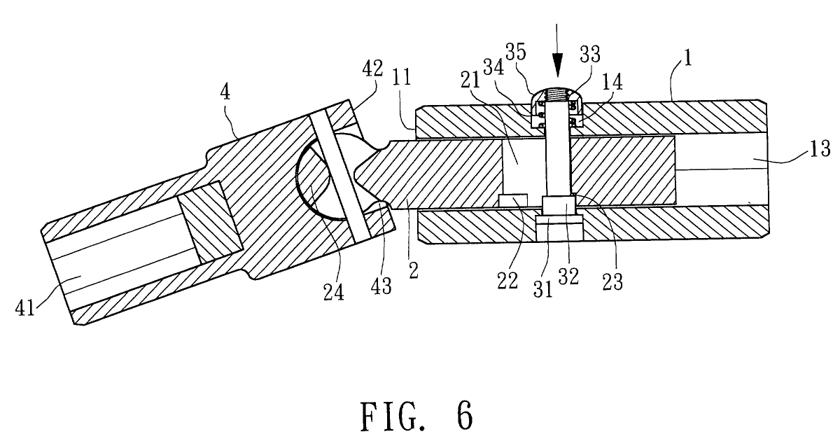

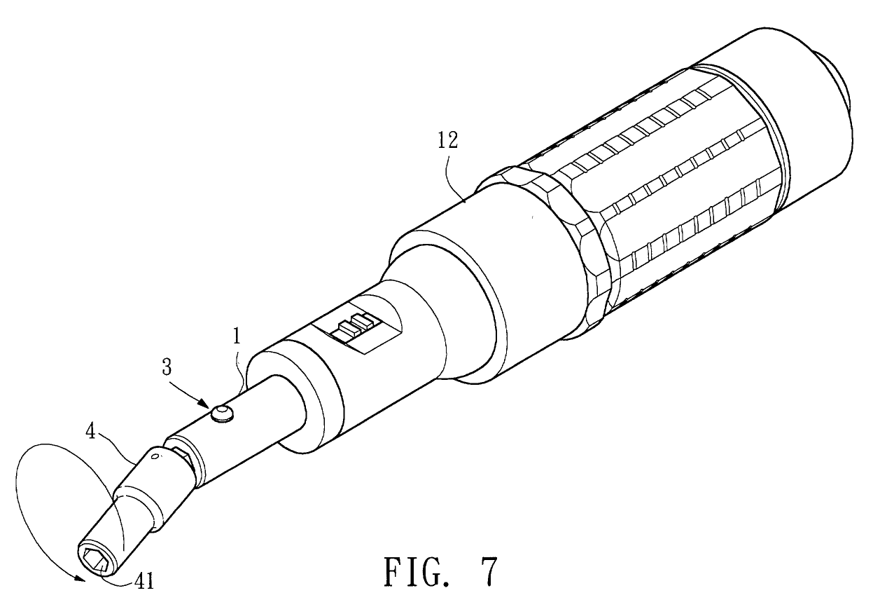

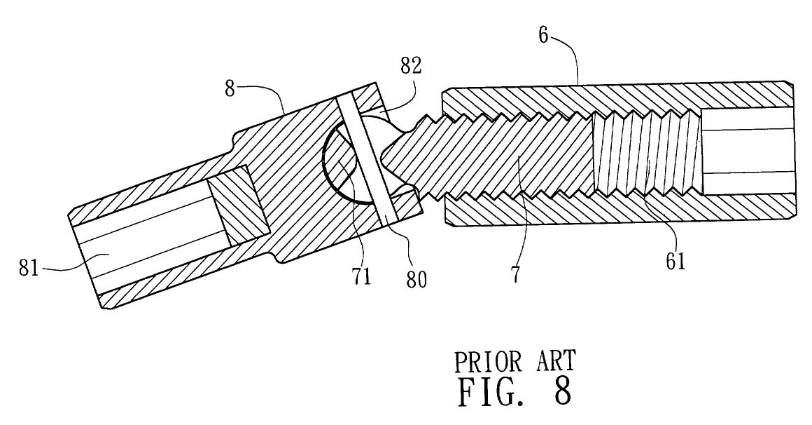

With reference to FIGS. 4-7, the button (35) is downward pressed and the stopper (32) is moved away from the firs recess (22) then the axle is free in the barrel (1) and chuck (4) is pulled to make the distal flat (42) of the chuck (4) being apart from the distal flat (11) of the barrel (1). Thus, the chuck (4) can be universally pivotally moved relative to the axle (2) and the spiral screwdriver can drive a work piece that is not along the axis of the barrel (1).

As described above, the drive device for a spiral screwdriver in accordance with the present invention is easy to operate and can be used as both of an ordinary screwdriver and a spiral screwdriver. Furthermore, the structure of the present invention is more stable than that of the conventional spiral screwdriver when using as an ordinary screwdriver.

Although the invention has been explained in relation to its preferred embodiment, it is to be understood that many other possible modifications and variations can be made without departing from the spirit and scope of the invention as hereinafter claimed.

What is claimed is:

1. A drive device for a spiral screwdriver, comprising:
a barrel including a first end adapted to be longitudinally and co-axially secured in a handle of the spiral screwdriver, a second end formed with a distal flat and a polygonal hole longitudinally defined in the barrel and extending to the distal flat of the barrel;
an axle movably and partially received in the polygonal hole in the barrel, the axle having a polygonal cross-section corresponding to that of the polygonal hole in the barrel;
a locking member extending through the barrel and the axle in the barrel to selectively hold the axle in place; and
a chuck selectively universally mounted to a free end of the axle and having a distal flat formed on a first end of the chuck, the distal flat of the chuck selectively abutting the distal flat on the barrel, the free end of the axle extending out of the barrel.

2. The drive device as claimed in claim 1, wherein the barrel comprises a first sunken hole and second sunken hole respectively defined in an outer periphery of the barrel and communicating with the polygonal hole in the barrel, and the axle comprises a slot defined in the axle and extending through the axle, the first sunken hole and the second sunken hole diametrically corresponding to each other and the slot in the axle communicating with the first sunken hole and the second sunken hole to allow the locking member extending through the barrel and the axle.

3. The drive device as claimed in claim 2, wherein the locking member comprises:
a dish movably received in the second sunken hole in the barrel;
a stopper extending from the dish, the stopper extending into the axle to selectively secure the axle;
a shank extending from the stopper, the shank extending through the slot and having a free end received in the first sunken hole in the barrel;
a button mounted on the free end of the shank to prevent the locking member from detaching from the barrel; and
a spring compressively mounted around the free end of the shank, the spring having two opposite ends respectively abutting the barrel and the button.

4. The drive device as claimed in claim 3, wherein the axle comprises a first recess and a second recess defined in an outer periphery of the axle to selectively the stopper of the locking member, the first recess and the second recess respectively centrally communicating with the slot in the axle, wherein there is a distance between the first recess and the chuck, which is shorter than that between the second recess and the chuck.

5. The drive device as claimed in claim 4, wherein the stopper of the locking member is received in the first recess of the axle and the distal flat of the chuck securely abuts the distal flat of the barrel such that the chuck longitudinally and co-axially corresponds to the barrel.

6. The drive device as claimed in claim 4, wherein the stopper of the locking member is received in the second recess of the axle and the chuck is pulled apart from the barrel such that the chuck is universally pivotally mounted on the free end of the axle.

7. The drive device as claimed in claim 1, wherein the axle comprises a spheroid portion formed on the free end of the axle and a sandglass-shaped passage defined in the spheroid portion, and the chuck comprises a socket defined in the first end of the chuck to rotatably received the spheroid portion of the axle, a locking pin securely and diametrically extending through the chuck and the sandglass-shaped passage in the axle to prevent the chuck from detaching from the axle, and a polygonal hole centrally longitudinally defined in a second end of the chuck, the polygonal hole in the chuck adapted to receive a tip for driving a work piece.

8. The drive device as claimed in claim 2, wherein the axle comprises a spheroid portion formed on the free end of the axle and a sandglass-shaped passage defined in the spheroid portion, and the chuck comprises a socket defined in the first end of the chuck to rotatably received the spheroid portion of the axle, a locking pin securely and diametrically extending through the chuck and the sandglass-shaped passage in the axle to prevent the chuck from detaching from the axle, and a polygonal hole centrally longitudinally defined in a second end of the chuck, the polygonal hole in the chuck adapted to receive a tip for driving a work piece.
